(19) United States
(12) Patent Application Publication
(10) Pub. No.: US 2008/0310253 A1
(43) Pub. Date: Dec. 18, 2008

(54) Multi-component mixing apparatus

(75) Inventor: Nobuyuki Hayashi, Tajimi-shi (JP)

Correspondence Address: OLIFF & BERRIDGE, PLC, P.O. BOX 320850, ALEXANDRIA, VA, 22320-4850, US

(73) Assignee: ASAHI SUNAC CORPORATION, Owariasahi-Shi (JP)

(21) Appl. No.: 12/149,660

(22) Filed: May 6, 2008

(30) Foreign Application Priority Data
Jun. 18, 2007 (JP) 2007-160157
Feb. 26, 2008 (JP) 2008-044665
Mar. 26, 2008 (JP) 2008-081414

(51) Int. Cl. B01F 13/08; B01F 9/00

(52) U.S. Cl. 366/343

(57) ABSTRACT

When a drive gear (a driving rotary assembly) is actuated and rotates the rotor (a driven rotary assembly), agitator blades rotate and agitate a base compound (a fluid) and a cure agent (a fluid) in an agitation cavity thereby shearing them. This agitation results in the base compound and the cure agent being mixed into a coating material. Furthermore, magnet force is used for giving rotation force to the rotor 50, and therefore any rotation force transmitting member that penetrates a cylindrical assembly is unnecessary. Therefore, such a rotation trouble caused by the fluids that enter into a gap between the transmitting member and the penetration, increases the viscosity therein, and adhere thereto does not occur.

### CROSS REFERENCE TO RELATED APPLICATION

This application claims priority from Japanese Patent Applications No. 2007-160157 filed on Jun. 18, 2007, No. 2008-044665 filed on Feb. 26, 2008, and No. 2008-081414 filed on Mar. 26, 2008. The entire content of these priority applications is incorporated herein by reference.

### TECHNICAL FIELD

The present invention relates to a multi-component mixing apparatus.

### BACKGROUND OF THE INVENTION

One known mixing apparatus for mixing a base compound with a cure agent is disclosed in Japanese Patent No. 3602203. The publication discloses a mixing apparatus for mixing a hydrophilic urethane component of two-component type with hydrophobic isocyanate as a cure agent. In the art, the urethane component and the hydrophobic isocyanate are previously quantitated and then squirted from opposing holes of about 0.2 mm-0.5 mm of the apparatus, with an applied high pressure at 3 MPa-5 MPa. The two flow and then collide with each other. The collision exerts shear force, which causes the disperse-resistant hydrophobic isocyanate to be dispersed and to be mixed into the well-mixed liquids.

The known mixing apparatus works in sufficiently dispersing and mixing the urethane component with the hydrophobic-isocyanate into the well-mixed liquids. However, this type of system used in the known mixing apparatus where materials are squirted from opposing holes of about 0.2 mm-0.5 mm, under applied high pressure at 3 MPa-5 MPa, thereby having the two flows collide with each other, to result in dispersing the materials in the mixed liquids. This system has difficulty in controlling the flow rate of the materials. Moreover, the system cannot be easily cleaned. Therefore, this system is difficult to practically use.

Thus, there is a need in the art for a simply constructed multi-component mixing apparatus that is superior in mixing performance and can be easily cleaned.

### SUMMARY OF THE INVENTION

One aspect of the present invention is a multi-component mixing apparatus that includes a cylindrical assembly having an agitation cavity defined therein. A plurality of fluids can flow in a flow direction through the agitation cavity. The multi-component mixing apparatus includes also a driving rotary assembly. The driving rotary assembly can perform a rotational movement along an outer surface of the cylindrical assembly and about an axis substantially parallel to the flow direction of the fluids in the agitation cavity. The multi-component mixing apparatus includes also a driving magnet disposed on the driving rotary assembly and a driven rotary assembly disposed in the cylindrical assembly. The driven rotary assembly can perform a rotational movement about an axis substantially coaxial with the driving rotary assembly. The multi-component mixing apparatus includes also a driven magnet disposed on the driven rotary assembly and an agitator blade disposed on the driven rotary assembly. The driven rotary assembly integrally performs a rotational movement with the rotational movement of the driving rotary assembly by magnetic force between the driving magnet and the driven magnet. The agitator blade is arranged to perform a rotational movement in a direction crossing the flow direction of the fluids in the agitation cavity in accordance with the rotational movement of the driven rotary assembly.

In accordance with this aspect, when the driving rotary assembly performs a rotational movement and produces the rotational movement of the driven rotary assembly, the agitator blade performs a rotational movement in the agitation cavity to agitate the fluids so as to shear them. This agitation results in the fluids being mixed. Even in a case of a low flow rate of the fluids, the agitation performance is maintained sufficient by increasing the rotation speed of the driving rotary assembly and thereby increasing the rotation speed of the agitator blade.

Note that another configuration could give rotation force to the driven rotary assembly accommodated in the cylindrical assembly. Namely, a transmitting member could be mounted on the driven rotary assembly so as to penetrate the cylindrical assembly to the outside. With this configuration, rotation force could be applied to the transmitting member, and the driven rotary member could integrally perform a rotational movement with the transmitting member. However, with such a configuration wherein the rotated transmitting member penetrates the cylindrical assembly, the fluids could enter into a gap between the transmitting member and a penetration in the cylindrical assembly, increase the viscosity therein, and adhere thereto. A possible rotation trouble of the driven rotary member is therefore a concern. In view of this, in accordance with the present invention, it is magnetic force that is used for giving rotation force to the driven rotary assembly. Therefore, such a rotation trouble of the driven rotary member possibly caused by increase in viscosity of the fluids as above described is avoided.

Another aspect of the present invention is that the multi-component mixing apparatus further includes a hole and a blocking portion. The hole and the blocking portion are located circumferentially adjacent to each other proximate to the agitator blade at an upstream side of the agitator blade in the agitation cavity. The hole allows the flow of the fluids therethrough. The blocking portion blocks the flow of the fluids.

With this aspect, a substantially laminar flow of the fluids is created while flowing through the hole. The substantially laminar flow is, right after flowing through the hole, agitated with being substantially perpendicularly sheared by the agitator blade and agitated. A shearing effect by the agitator blade is therefore improved. The fluids are thus desirably mixed.

Another aspect of the present invention is that the multi-component mixing apparatus further includes an agitation chamber that is partitioned from the outside. The agitator blade performs the movement in the agitation chamber.

With this aspect, the fluids do not easily flow out of the agitation chamber even when they receive agitation force from the agitator blade. Agitation is therefore effectively performed.

Another aspect of the present invention is that the multi-component mixing apparatus further includes a rotation-crossing blade that is disposed on an inner surface of the cylindrical assembly. The rotation-crossing blade extends in a direction crossing a rotational direction of the agitator blade.

With the blade of this aspect, a flow of the fluids produced by the rotational movement of the driven rotary assembly is directed outwardly (toward the outside, or toward the inner surface of the cylindrical assembly). The fluids are therefore sheared between the blade and an outer end of the agitator blade. Since the rotary speed of the agitator blade is the fastest at the outer end thereof, dispersion of the fluids is thus more effectively performed. Furthermore, the rotational movement of the agitator blade produces centrifugal force, which producing a convecting flow of the fluids between an outer end portion of the agitator blade and an inner end portion of the agitator blade. As a result of the convecting flow, the fluids are repeatedly sheared between the blade and the agitator blade. Therefore, the fluids do not easily stagnate at the inner portion of the agitator blade, and sufficient agitation can be performed. With this aspect, furthermore, since a mixing operation is realized by the agitator blade and the blade, the configurations are simpler and therefore can be easily cleaned. The apparatus is thus extremely superior in practical use.

Another aspect of the present invention is that the rotation-crossing blade and the agitator blade of the multi-component mixing apparatus define a clearance equal to or larger than 0.1 mm.

With this aspect, the rotation-crossing blade and the agitator blade define the clearance equal to or larger than 0.1 mm. the agitator blade thus safely rotates with being apart from the blade and producing the convecting flow of the fluids. Note that the clearance may be more preferably equal to or larger than 0.3 mm. In this case, the rotational movement is continuously and more stably performed.

Another aspect of the present invention is that the multi-component mixing apparatus further includes a flow-crossing blade that is disposed on an inner surface of the cylindrical assembly along a circumferential direction of the driven rotary assembly. The flow-crossing blade extends in the direction crossing the flow direction of the fluids.

Though the clearance between the agitator blade and the inner surface of the cylindrical assembly is necessary, the fluids can flow along the wall (the inner wall of the cylindrical assembly), with bypassing agitation by the agitator blades. In this case, the fluids are not sufficiently agitated, and the agitation performance becomes lower. In view of this, the flow-crossing blade (the second blade) as above, which is circumferentially disposed on the driven rotary assembly and extends in the direction crossing the flow direction of the fluids, inwardly direct the fluids flowing through the agitation cavity in the cylindrical assembly. The fluids are thus reliably agitated by the agitator blade.

Furthermore, In the case where the rotation-crossing blade (the first blade) is provided, the rotation-crossing blade (the first blade) extends from the inner surface of the cylindrical assembly. This accompanies a clearance between the inner surface of the cylindrical assembly and the outer end of the agitator blades. In other words, this accompanies the clearance whereinto the agitator blade is allowed to push out the fluids. Such a clearance still more easily causes a trouble, similarly to the above case, that the fluids flow along a wall of the clearance, thereby bypassing agitation. Consequently, it is more preferable for the multi-component apparatus having the rotation-crossing blades (the first blades) to further have the flow-crossing blades (the second blades) as above.

Another aspect of the present invention is that the flow-crossing blade includes at least two members disposed apart from each other in the flow direction of the fluids in the agitation cavity.

With this aspect, at least two flow-crossing blades (the second blades) are disposed apart from each other. This more reliably directs the flow of the fluids toward the agitator blades. Thus, the fluids are more reliably sheared between the agitator blade and the rotation-crossing blade (the first blade) and thus be mixed. Furthermore, such blades disposed at the plurality of levels make it unnecessary to provide a plurality of levels of agitator cavities. The apparatus and its control is thus made simpler.

Note that the clearance between the above described flow-crossing blade and the agitator blade may be equal to or larger than 0.1 mm. The clearance equal to or larger than 0.1 mm allows the agitator blade to safely perform the rotational movement, while being apart from the flow-crossing blade, and produce the convecting flow of the fluids. Note that the clearance may be more preferably equal to or more than 0.3 mm. In this case, the rotational movement can be continuously and more stably performed. Furthermore, the top of the flow-crossing blade extends to the height the same as the top of the rotation-crossing blade, and the top of the flow-crossing blade is continuous with the top of the rotation-crossing blade. With this configuration, both the flow-crossing blade and the rotation-crossing blade serves for more effectively agitating and mixing the fluids. Furthermore, the flow-crossing blade and the rotation-crossing blade may be formed with similar material by raising the inner surface of the cylindrical assembly.

The multi-component mixing apparatus of the present invention provides an improved mixing performance, allows for easy cleaning and a simplified configuration for ease of use.

### BRIEF DESCRIPTION OF THE DRAWINGS

FIG. 1 is a longitudinal sectional view showing a multi-component mixing apparatus of a first embodiment;

FIG. 2 is a longitudinal sectional view of a rotor and a body having a cylindrical assembly;

FIG. 3 is a longitudinal sectional view of the body;

FIG. 4 is a partly broken sectional view showing a whole configuration of the rotor;

FIG. 5 is an axial cross-sectional view showing agitator blades in relation to a body;

FIG. 6 is a sectional view showing agitator blades in relation to a body in a modified embodiment;

FIG. 7 is a longitudinal sectional view showing a multi-component mixing apparatus of a second embodiment;

FIG. 8 is a longitudinal sectional view of a body having a cylindrical assembly;

FIG. 9 is a plan view of the body;

FIG. 10 is a front view of a rotor;

FIG. 11 is a longitudinal sectional view of the rotor;

FIG. 12 is a plan view of the rotor;

FIG. 13 is a bottom view of the rotor;

FIG. 14 is a longitudinal sectional view showing a multi-component mixing apparatus of a third embodiment;

FIG. 15 is a longitudinal sectional view of a rotor and a body having a cylindrical assembly;

FIG. 16 is a longitudinal sectional view of the body;

FIG. 17 is a sectional view taken substantially along line A-A′ of FIG. 15;

FIG. 18 is a sectional view taken substantially along line B-B′ of FIG. 15;

FIG. 19 is a sectional view showing a modified illustration of blades; and

FIG. 20 is a sectional view showing a modified illustration of the blades.

### DETAILED DESCRIPTION OF THE PREFERRED ILLUSTRATIVE ASPECTS

### First Preferred Embodiment

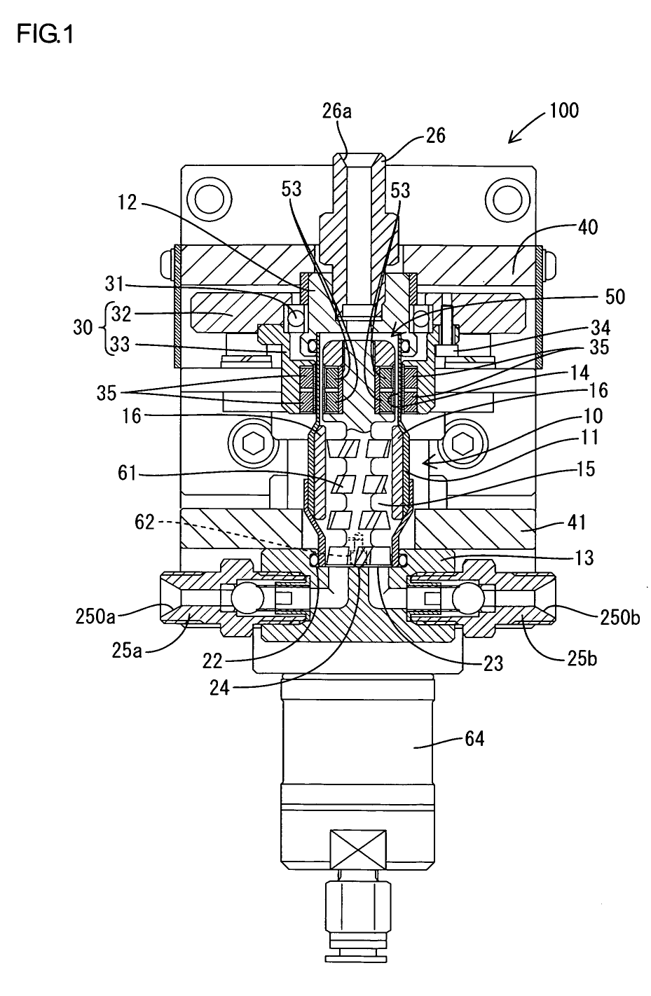

A first preferred embodiment in accordance with the present invention will be described with reference to FIGS. 1 through 5. A multi-component mixing apparatus 100 of this embodiment is arranged for mixing fluids each at required proportions. The fluids are, for example, a base compound such as a urethane component that is one of waterborne coating components, and a cure agent such as a hydrophobic isocyanate component. The base compound and the cure agent are supplied into the multi-component mixing apparatus 100 each at respective required flow rates, mixed therein into a well-mixed liquids of a two-component coating material. The well-mixed liquids are then supplied to a paint gun (not illustrated).

As shown in FIG. 1, the multi-component mixing apparatus 100 includes an assembly 10, a drive gear 30 (that corresponds to a driving rotary assembly), and a rotor 50 (that corresponds to a driven rotary assembly). In this aspect, the assembly 10 includes a cylindrical shape.

The cylindrical assembly 10 includes a cylindrical body 11 made of nonmagnetic material, a cylindrical upper support 12, and a cylindrical lower support 13. The body 11 orients the axis thereof vertical. An upper aperture of the body 11 is fitted in the upper support 12 coaxially therewith, and a lower aperture of the body 11 is fitted in the lower support 13 coaxially therewith. The cylindrical assembly 10 is vertically held between an upper base plate 40 and a lower base plate 41. The cylindrical assembly 10 is thus fixedly supported by the upper base plate 40 and the lower base plate 41. The cylindrical assembly 10 is hollow therein. A substantial portion of the upper half of the hollow defines a magnet accommodation cavity 14, and a substantial portion of the lower half of the hollow defines an agitation cavity 15.

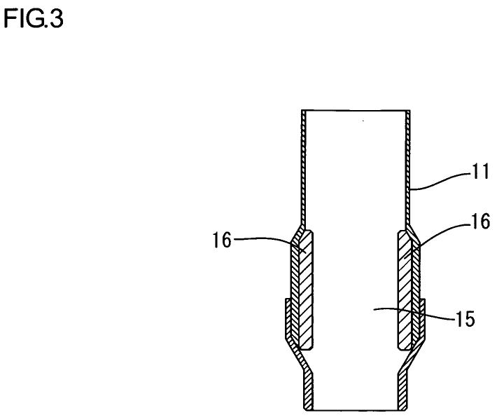

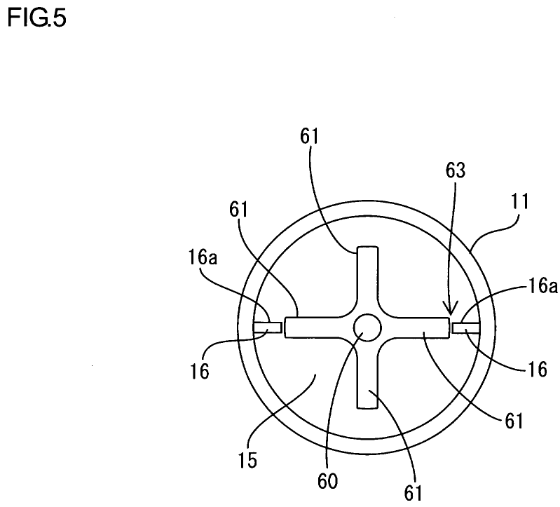

The agitation cavity 15 has blades 16 (rotation-crossing blades) disposed therein for shearing a rotational flow of the fluids. As shown both in FIGS. 3 and 5, each of the blades 16 extends from an inner surface of the body 11. In this embodiment, two blades 16 are disposed in diametrically opposed positions. The blades 16 are, for example, applied on the body 11 with a welding process. Each of the blades 16 extends from the inner surface of the body 11 in a direction crossing an agitated direction of the fluids.

Held between a lower end surface of the body 11 and the lower support 13 is a flat bearing plate 22, as shown in FIG. 1. The bearing plate 22 is disposed perpendicular to the axis of the body 11. The bearing plate 22 has a plurality of holes 23 formed therethrough in a thickness-wise direction thereof. Each of the holes 23 is off of a center point of the bearing plate 22. The holes 23 are circumferentially spaced from each other. The bearing plate 22 includes a bearing portion 24 in the center thereof.

As shown in FIG. 1, inlet joints 25a, 25b are secured to the lower support 13, and a cylindrical outlet joint 26 is secured to the upper support 12. The outlet joint 26 orients the axis thereof vertical. The inlet joints 25a, 25b include inlet ports 250a, 250b, respectively, and are formed therein. The inlet ports 250a, 250b are connected to a base compound supply source (not illustrated) and a cure agent supply source (not illustrated), respectively. The outlet joint 26 includes an outlet port 26a formed therein. The outlet port 26a is connected to a spray gun (not illustrated) . The inlet ports 250a, 250b are in communication with the agitation cavity 15 via the lower support 13. The outlet port 26a is in communication with the agitation cavity 15 via the upper support 12. The base compound and the cure agent are supplied from the inlet ports 250a, 250b into the cylindrical assembly 10, flow up (generally parallel to the axis of the cylindrical assembly 10) in the cylindrical assembly 10, and flow from the outlet 26a out of the cylindrical assembly 10.

The drive gear 30 is cylindrical and made of nonmagnetic material. The drive gear 30 is supported by a bearing 31 around an outer surface of the upper support 12. The drive gear 30 is coaxial with the cylindrical assembly 10. The drive gear 30 is restricted in relative movement in a vertical direction (in an axial direction of the drive gear 30). The drive gear 30 is allowed for a rotational movement about an axis coaxial with the cylindrical assembly 10. The drive gear 30 includes a cylindrical gear body 32 and a cylindrical magnet holder 33. The gear body 32 and the magnet holder 33 are assembled with bolts 34 so as to integrally perform the rotational movement. Attached to the magnet holder 33 are even numbers of driving magnets 35. The driving magnets 35 are circumferentially spaced from each other on the magnet holder 33. The driving magnets 35 are disposed on an inner surface of the magnet holder 33, with north poles and south poles being alternately aligned thereon. The driving magnets 35 are closely opposed to the outer surface of the body 11 of the cylindrical assembly 10. The driving magnets 35 are thus arranged to perform a rotational movement along the outer surface of the body 11 in accordance with the rotational movement of the drive gear 30.

A motor 64 is installed on the upper base plate 40. The motor 64 has an output shaft. An output gear (not illustrated) is mounted to the output shaft. The output shaft and the output gear thus integrally perform a rotational movement. The output gear has a meshing engagement with the drive gear 30. When the motor 64 runs, rotation force from the motor 64 is transferred via the output gear to the drive gear 30. The drive gear 30 is thus actuated to perform the rotational movement.

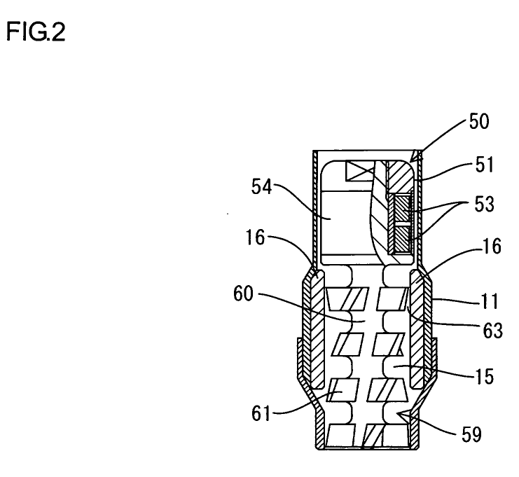

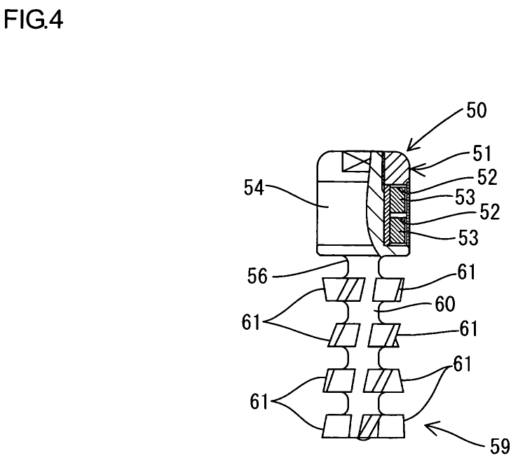

The rotor 50 is made of nonmagnetic materials and is accommodated in the hollow of the cylindrical assembly 10. As shown in FIG. 4, a substantial portion of the upper half of the rotor 50 is a generally column-shaped magnet holder 51, while a substantial portion of the lower half of the rotor 50 is a generally column-shaped agitator 59. The outside diameter of the magnet holder 51 is slightly smaller than the inside diameter of the body 11 (see FIG. 2). The magnet holder 51 includes concavities 52 defined on an outer surface thereof. The concavities 52 are equal in number to the driving magnets 35. A plurality of driven magnets 53 are accommodated in the concavities 52. The driven magnets 53 are opposed to the driving magnets 35. The driven magnets 53 are disposed on the outside of the concavities 52, with north poles and south poles being alternately aligned on the outside thereof. Note that the driven magnets 53 include covers 54 attached to openings of the concavities 52, and thus the driven magnets 53 are prevented from contact with the base compound and the cure agent.

The agitator 59 includes a column-shaped support leg 60 and a plurality of agitator blades 61. The support leg 60 is coaxial with the magnet holder 51. The outside diameter of the support leg 60 is smaller than a narrow portion 56 of the magnet holder 51. The agitator blades 61 are disposed on an outer surface of the support leg 60. An upper end of the support leg 60 is connected to a lower end surface of the narrow portion 56 of the magnet holder 51. The agitator 59 and the magnet holder 51 are thus arranged to integrally perform a rotational movement. A bearing ball 62 is disposed at a lower end of the support leg 60, as shown in FIG. 1. Four agitator blades 61 are disposed in a horizontal plane to define one set. Four sets of the agitator blades 61 are disposed with being spaced from each other in an axial direction (the vertical direction in FIG. 5) of the rotor 50. Consequently, sixteen agitator blades 61 in total are disposed around the support leg 60. Each of the sixteen agitator blades 61 is plate-shaped, and its surfaces are spirally oblique on the outer surface of the support leg 60. In other words, the surfaces (in this aspect having a generally flat characteristic) of the agitator blades 61 are slightly inclined to the axis of the support leg 60.

As above described, the blades 16 are disposed on the inner surface of the body 11. In addition, in this embodiment, there is a clearance 63 between the blades 16 and the agitator blades 61. The clearance 63 is arranged to be equal to or larger than 0.1 mm (more preferably, to be equal to or larger than 0.3 mm), which is enough for allowing the agitator blades 61 to smoothly perform a rotational movement without making any contact with the blades 16. Note that the blades 16 are arranged for shearing the rotational flow of the fluids in the agitation cavity 15 as described above, and therefore extend in the direction crossing the rotational direction of the agitator blades 61. That is, each of the blades 16 includes a standing wall 16a that extends perpendicular to the rotational direction of the agitator blades 61.

As shown in FIG. 1, the bearing ball 62 of the above described rotor 50 is disposed on an upper surface of the bearing plate 24. The rotor 50 is thus supported in the body 11 (in the cylindrical assembly 10) so as to perform a free rotational movement about the axis coaxial with the body 11, with keeping a posture substantially coaxial with the cylindrical assembly 10 and the drive gear 30. The magnet holder 51 (including the narrow portion 56) of the rotor 50 is accommodated in the magnet accommodation cavity 14 of the body 11. The driven magnets 53 which orient the north pole thereof outward are opposed to the respective driving magnets 35 which orient the south pole thereof inward in same levels. The driven magnets 53 which orient the south pole thereof outward are opposed to the respective driving magnets 35 which orient the north pole thereof inward in same levels. Magnetic attractive force, which is radially produced between the opposing driving magnets 35 and the respective driven magnets 53, makes the rotor 50 integrally perform the rotational movement with the drive gear 30. In addition, the rotor 50 is kept in the posture coaxial with the body 11 without leaning because the magnetic attractive force is exerted at circumferentially equal angles on the rotor 50.

The operation of this embodiment will be now described.

First, when mixing the base compound with the cure agent, the drive gear 30 is actuated by the motor 64. The rotor 50 then starts the rotational movement in the cylindrical assembly 10. In this state, the base compound and the cure agent are supplied from the respective inlet ports 250a, 250b into the agitation cavity 15 of the cylindrical assembly 10. Since each of the base compound and the cure agent is led directly into the agitation cavity 15 of the cylindrical assembly 10, the two fluids are not mixed until they enter the cylindrical assembly 10.

In the agitation cavity 15, the agitator blades 61 produce the rotational flow of the base compound and the cure agent, and the rotational flow agitates the base compound and the cure agent. The flow of the fluids produced by the rotational flow is directed outwardly (centrifugally). On the other hand, the blades 16 radially extend from the inner surface of the body 11. The fluids are therefore sheared between the blades 16 and the outer ends of the agitator blades 61. Since the rotary speed of the agitator blades 61 is the fastest at the outer ends thereof, agitation of the fluids is thus more effectively performed. Furthermore, the rotational movement of the agitator blades 61 produces centrifugal force, which produces a convecting flow of the fluids between the outer portions of the agitator blades 61 and inner portions of the agitator blades 61. Inner portions (the basal end side portions) of the agitator blades 61, which would less serve for agitation in nature than the outer portions, thus also serve for sufficient agitation.

The fluids are thus sufficiently agitated and mixed in the agitation cavity 15 into the well-mixed liquids as above described, and the well-mixed liquids flows through a clearance defined between the magnet holder 51 and the body 11, and flow from the outlet port 26a out of the cylindrical assembly 10 (out of the agitation cavity 15) (for example, towards the paint gun).

With the above described multi-component mixing apparatus 100 of this embodiment, the base component and the cure agent are sufficiently agitated and mixed. Specifically, even in a case of mixing the waterborne base component and the hydrophobic component that are less miscible with each other such as in this embodiment, the shearing effect produced by the rotational movement of the agitator blades 61 and the blades 16 realizes a higher agitation and mixing performance. Furthermore, even in a case of a lower flow rate of the base component and the cure agent in the cylindrical assembly 10 (in a case of a lower flow rate per hour), the agitation performance can be further improved by increasing a rotary speed of the drive gear 30, i.e. a rotary speed of the agitator blades 61.

In this embodiment, meanwhile, another configuration could give rotation force to the rotor 50 accommodated in the cylindrical assembly 10. Namely, a transmitting member could be mounted on the rotor 50 so as to penetrate the cylindrical assembly 10 to the outside. With this configuration, rotation force could be applied to the transmitting member, and the rotor 50 could integrally perform a rotational movement with the transmitting member. However, with such a configuration wherein the rotated transmitting member penetrates the cylindrical assembly 10, the fluids could enter into a gap between the transmitting member and a penetration in the cylindrical assembly 10, increase the viscosity therein, and adhere thereto. A possible rotation trouble of the transmitting member and the rotor 50 is therefore a concern. In view of this, in this embodiment, magnetic force is used for giving rotation force to the rotor 50. Therefore, rotation trouble possibly caused by increase in viscosity of the fluids as described above is thus avoided.

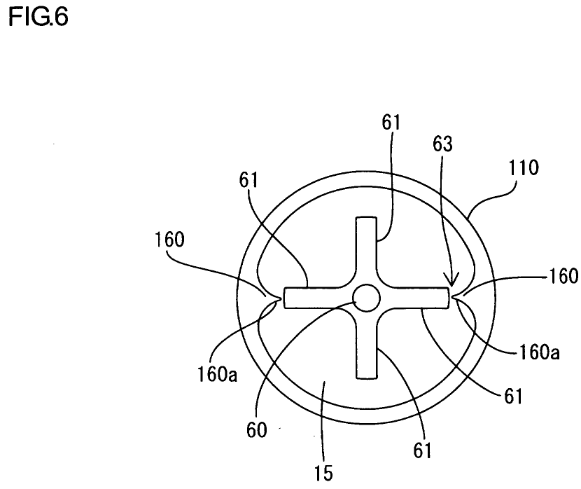

Note that though the blades 16 are protruding tips applied on the body 11 with the welding process in this embodiment, the blades 16 may be integrally formed with the body 11 by processing the body 11 as illustrated in FIG. 6. That is, a body 110 includes blades 160, as shown in FIG. 6, that are formed when the the body 110 is being processed. In this case, though standing walls 160a of the blades 160 cross the rotational direction of the agitator blades 61, the standing walls 160a have slightly curved smooth inclined surfaces. This reduces fluids that can stagnate at basal end portions of the blades 160. The fluids are therefore sufficiently agitated also at the basal end portions of the blades 160.

### Second Preferred Embodiment

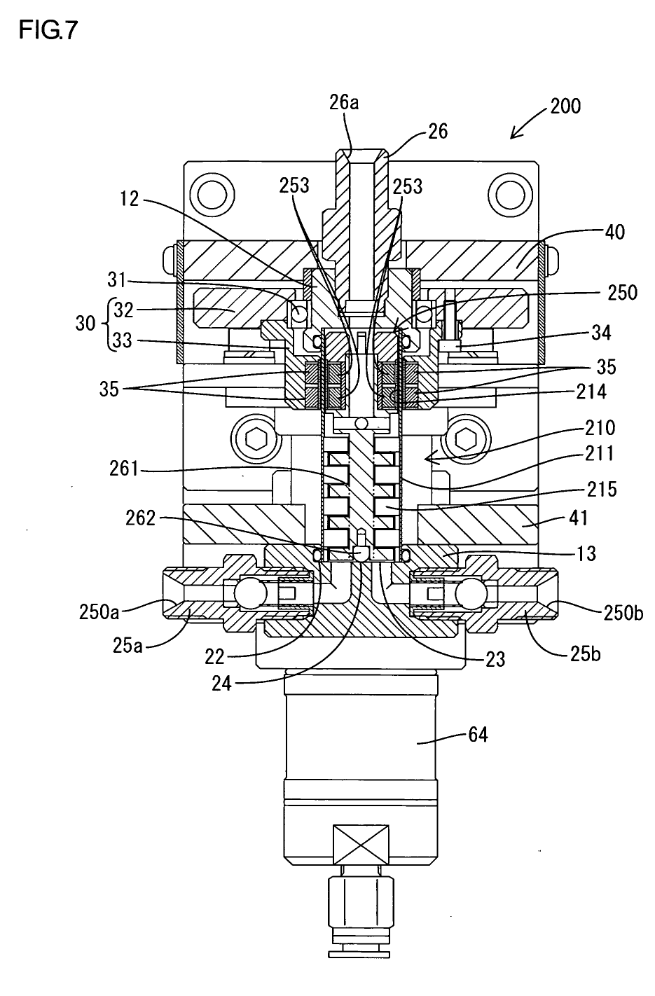

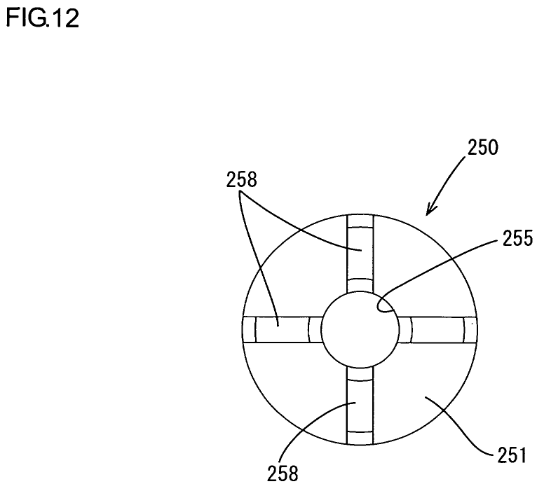

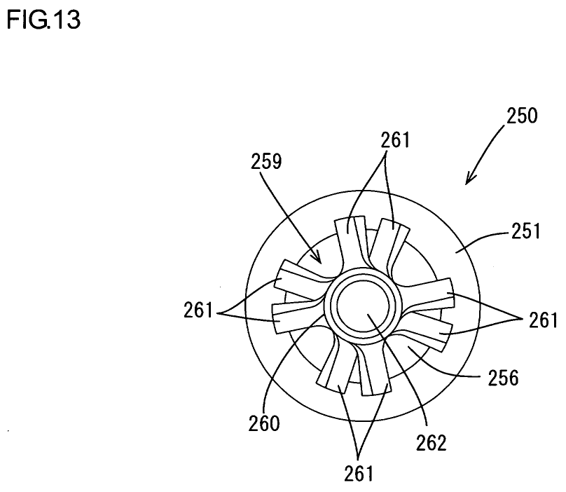

A second preferred embodiment in accordance with the present invention will be now described with reference to FIGS. 7 to 13. A multi-component mixing apparatus 200 of this embodiment is, similar to that of the first embodiment, arranged for mixing fluids each at required proportions. The fluids are, for example, a base compound such as a urethane component that is one of waterborne coating components, and a cure agent such as a hydrophobic isocyanate component. The multi-component mixing apparatus 200 includes a cylindrical assembly 210 and a rotor 250 each having different configurations from those of the multi-component mixing apparatus 100 of the first embodiment. Configurations similar to the multi-component mixing apparatus 100 of the first embodiment are designated with same numerals in FIGS. 7 through 13, while the explanations are omitted.

As shown in FIG. 7, the multi-component mixing apparatus 200 includes the assembly 210, in this aspect having a cylindrical shape. The cylindrical assembly 210 includes a cylindrical body 211 made of nonmagnetic material, the cylindrical upper support 12, and the cylindrical lower support 13. The body 211 orients the axis thereof vertical. An upper aperture of the body 211 is fitted in the upper support 12 coaxially therewith, and a lower aperture of the body 211 is fitted in the lower support 13 coaxially therewith. The cylindrical assembly 210 is vertically held between the upper base plate 40 and the lower base plate 41. The cylindrical assembly 210 is thus fixedly supported by the upper base plate 40 and the lower base plate 41. The cylindrical assembly 210 is hollow therein. A substantial portion of the upper half of the hollow defines a magnet accommodation cavity 214, and a substantial portion of the lower half of the hollow defines an agitation cavity 215.

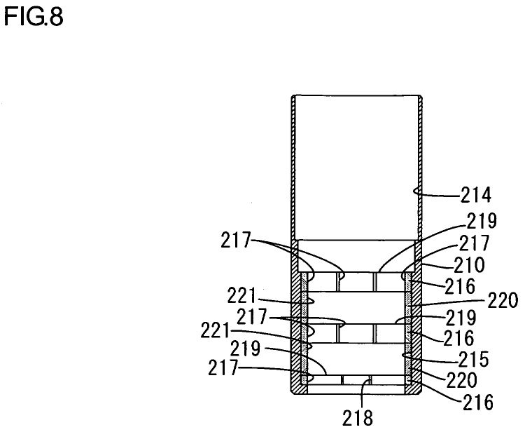

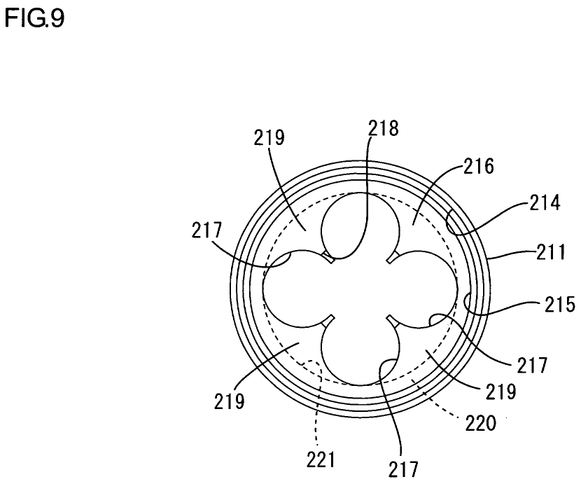

As shown in FIGS. 8 and 9, three partition plates 216 and two spacers 220 are vertically and alternately stacked in the agitation cavity 215. The partition plates 216 are circular plate-shaped and positioned in the body 211 perpendicular to the axis of the body 211. The partition plates 216 are fitted to an inner surface of the body 211 so as not to radially and circumferentially move therein. The spacers 220 are cylindrical. The spacers 220 are fitted to an inner surface of the body 211 so as not to radially move therein. Each of the partition plates 216 has four circular holes 217 and a center hole 218 that are thicknesswisely defined therethrough. The holes 217 are spaced from each other circumferentially at equal angles. The center hole 218 is coaxial with the partition plate 216. The center hole 218 is in communication with each of the four holes 217. Four portions of the partition plate 216 (other than the holes 217 and the center hole 218) constitute wedge-shaped (substantially triangular) blocking portions 219. The three partition plates 216 are positioned with being vertically spaced from each other by the spacers 220. In addition, the three partition plates 216 each are disposed such that the respective holes 217 thereof are at same circumferential positions. In other words, respective holes 217 of the three partition plates 216 each are disposed in vertically overlapping relation with each other. The holes 217 are arranged to allow the base compound and the cure agent that has flown into the body 211 to further flow therethrough. On the other hand, the blocking portions 219 are arranged to block the flow of the base compound and the cure agent. The agitation cavity 215 is partitioned by the three partition plates 216 and aligned in the axial direction of the cylindrical assembly 210, thereby defining two agitation chambers 221. The agitation chambers 221 each are defined on same levels with the respective spacers 220.

As shown in FIG. 7, held between a lower end surface of the body 211 and the lower support 13 is the flat bearing plate 22. The bearing plate 22 is disposed perpendicular to the axis of the body 211. The bearing plate 22 has the plurality of holes 23 thicknesswisely formed therethrough. Each of the holes 23 is off of the center point of the bearing plate 22. The holes 23 are circumferentially spaced from each other. The bearing plate 22 includes the bearing portion 24 in the center thereof.

The lower support 13 has the inlet joints 25a, 25b secured thereto. The upper support 12 has the cylindrical outlet joint 26 secured thereto. The outlet joint 26 orients the axis thereof vertical. The inlet joints 25a, 25b include the inlet ports 250a, 250b formed therein. The inlet ports 250a, 250b are connected to the base compound supply source (not illustrated) and the cure agent supply source (not illustrated), respectively. The outlet joint 26 includes the outlet port 26a. The outlet port 26a is connected to the spray gun (not illustrated). The inlet ports 250a, 250b are in communication with the agitation cavity 15 via the lower support 13. The outlet port 26a is in communication with the agitation cavity 15 via the upper support 12. The base compound and the cure agent are supplied from the inlet ports 250a, 250b to the cylindrical assembly 210, flow up (generally parallel to the axis of the cylindrical assembly 210) in the cylindrical assembly 210, and flow from the outlet 26a out of the cylindrical assembly 210.

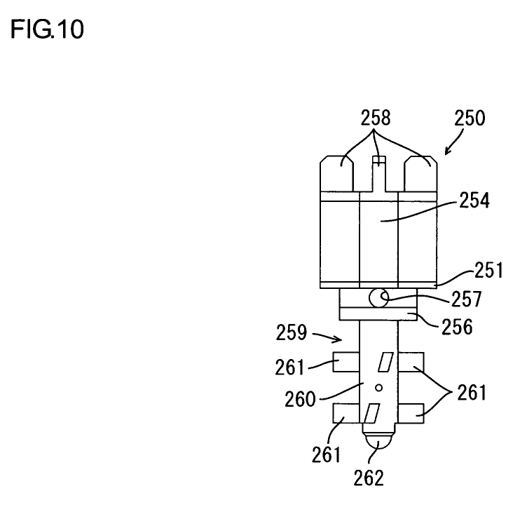

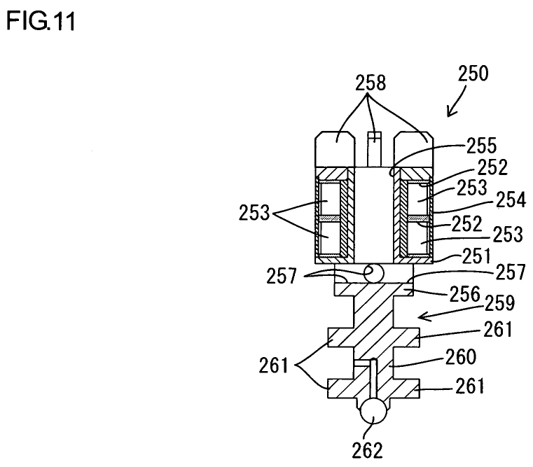

As shown in FIGS. 10 through 13, the rotor 250 is made of nonmagnetic material and is accommodated within the hollow of the cylindrical assembly 210. As shown in FIGS. 10 and 11, a substantial portion of the upper half portion of the rotor 250 is a generally column-shaped magnet holder 251, and a substantial portion of the lower half portion of the rotor 50 is a generally column-shaped agitator 259. The outside diameter of the magnet holder 251 is slightly smaller than the inside diameter of the body 211. The magnet holder 251 includes concavities 252 defined on an outer surface thereof. The concavities 252 are equal in number to driving magnets 35. A plurality of driven magnets 253 are accommodated in the concavities 252. The driven magnets 253 are equal in number to the driving magnets 35. The driven magnets 253 are disposed with north poles and south poles being alternately aligned on the outside thereof. Note that the driven magnets 253 are covered over with covers 254 attached to openings of the concavities 252, and thus the driven magnets 253 are prevented from a contact with the base compound and the cure agent.

As shown in FIG. 11, the magnet holder 251 includes a passageway 255. The passageway 255 is coaxial with the magnet holder 251. The passageway 255 has an opening defined in an upper end of the magnet holder 251. A lower end of the magnet holder 251 is a narrow portion 256. The narrow portion 256 is coaxial with the magnet holder 251 and is narrower in diameter than the magnet holder 251. The narrow portion 256 includes four communication holes 257 radially defined therein from an outer surface thereof toward the axis thereof. Each of the communication holes 257 is in communication with a lower end of the passageway 255 at the axis of the narrow portion 256. In addition, four plate-shaped fins 258 extend upwardly from an upper end surface of the magnet holder 251. The fins 258 are positioned around the opening of the passageway 255. Flat surfaces of each of the fins 258 are substantially radially disposed, and therefore the fins 258 rotate substantially perpendicular to the surfaces thereof when the rotor 250 performs a rotational movement.

The agitator 259 includes a column-shaped support leg 260 and a plurality of agitator blades 261. The support leg 260 is coaxial with the magnet holder 251. The outside diameter of the support leg 260 is smaller than a narrow portion 256 of the magnet holder 251. The agitator blades 261 are disposed around an outer surface of the support leg 260. An upper end of the support leg 260 is connected to a lower end of the narrow portion 256 of the magnet holder 251. The agitator 259 and the magnet holder 251 are thus arranged to integrally perform a rotational movement. A lower end of the support leg 260 is provided with a bearing ball 262. A substantially upper half of the bearing ball 262 is embedded and fixed in the support leg 260. The agitator blades 261 define two sets, and each of the sets are disposed at respective one of two levels of the support leg 260. The two levels are spaced from each other in the axial (vertical) direction of the rotor 250. The agitator blades 261 are eight in total number. Four of the eight agitator blades 261 are disposed at the upper level of the support leg 260, being circumferentially spaced from each other at equal angles. The other four agitator blades 261 are disposed at the lower level of the support leg 260, likewise with being circumferentially spaced from each other at equal angles. In addition, each of the agitator blades 261 is plate-shaped, and its flat surfaces are spirally oblique on the outer surface of the support leg 260. In other words, the flat surfaces of the agitator blades 261 are slightly inclined to the axis of the support leg 260.

As shown in FIG. 7, the bearing ball 262 of the above described rotor 250 abuts on the upper surface of the bearing plate 24. The rotor 250 is thus supported in the body 211 (in the cylindrical assembly 210) so as to freely perform the rotational movement about the axis coaxial with the body 211, with keeping a posture substantially coaxial with the cylindrical assembly 210 and the drive gear 30. The magnet holder 251 (including the narrow portion 256) of the rotor 250 is accommodated in the magnet accommodation cavity 214 in the body 211. The driven magnets 253 which orient the north pole thereof outward are opposed to the respective driving magnets 35 which orient the south pole thereof inward in same levels. The driven magnets 253 which orient the south pole thereof outward are opposed to the respective driving magnets 35 which orient the north pole thereof inward in same levels. Magnetic attractive force, which is radially produced between the driving magnets 35 and the respective driven magnets 253, makes the rotor 250 integrally perform the rotational movement with the drive gear 30. In addition, because the magnetic attractive force is exerted on the rotor 250 at circumferentially equal angles, the rotor 250 is kept in the posture coaxial with the body 211 without leaning.

The agitator 259 is accommodated in the agitation cavity 215. The support leg 260 is positioned through the center holes 218 of the three partition plates 216. The agitator blades 261 at the upper level are accommodated in the agitation chamber 221 which is at the same level with the upper spacer 220 (at the level between the uppermost and the middle partition plates 216) so as to horizontally perform a rotational movement. The agitator blades 261 at the lower level are accommodated in the agitation chamber 221 which is at the same level with the lower spacer 220 (at the level between the middle and the lowermost partition plates 216) so as to horizontally perform a rotational movement. That is, in this state, the holes 217 and the blocking portions 219 of each of the partition plates 216 are located circumferentially adjacent to each other proximate to the agitator blades 261 (at the upstream side in the flow of the base component and the cure agent), and the holes 217 allow the flow of the base component and the cure agent while the blocking portions 219 block the flow of the base component and the cure agent.

The operation of this embodiment will be now explained.

First, when mixing the base compound with the cure agent, the drive gear 30 is actuated by the motor 64. The rotor 250 then starts the rotational movement in the cylindrical assembly 210. In this state, the base compound and the cure agent are supplied from the inlet ports 250a, 250b into the agitation cavity 215 of the cylindrical assembly 210. Since each of the base compound and the cure agent are led directly into the agitation cavity 215 of the cylindrical assembly 210, the two fluids are not mixed until they enter the cylindrical assembly 210.

While the base compound and the cure agent flow in the agitation chamber 221, the plurality of agitator blades 261 horizontally perform the rotational movement, i.e. substantially perpendicular to the flowing direction of the base component and the cure agent (to the direction parallel to the axis of the cylindrical assembly 210), thereby crossing the flow of the base component and the cure agent substantially perpendicular thereto. The base component and the cure agent are thus agitated and sheared by the agitator blades 261, and are mixed each in required proportions into the well-mixed liquids of the coating material.

Furthermore, the holes 217 and the blocking portions 219 are disposed circumferentially adjacent to each other in the agitation cavity 215. The holes 217 allow the base component and the cure agent to flow therethrough, while the blocking portions 219 block the flow of the base component and the cure agent. This creates substantially laminar flows of the base component and the cure agent while flowing through the holes 217. After flowing through the holes 217, the substantially laminar flows are, sheared by the agitator blades 261 substantially perpendicularly, while also being agitated. Shearing effect by the agitator blades 261 is therefore higher. The base component and the cure agent are thus desirably mixed.

Furthermore, because areas wherein the agitator blades 261 perform the rotational movement is partitioned as the agitation chambers 221 from the outside, the base component and the cure agent in the agitation chambers 221 do not easily flow out of the agitation chambers 221 even when they receive agitation force from the agitator blades 261. Better agitation performance for the base component and the cure agent is thus obtained.

The base component and the cure agent is thus sufficiently agitated in the agitation cavity 215 into the well-mixed liquids. The well-mixed liquids then flows through the clearance defined between the magnet holder 251 and the body 211, and flows from the outlet port 26a out of the cylindrical assembly 210 (outside the agitation cavity 215).

### Third Preferred Embodiment

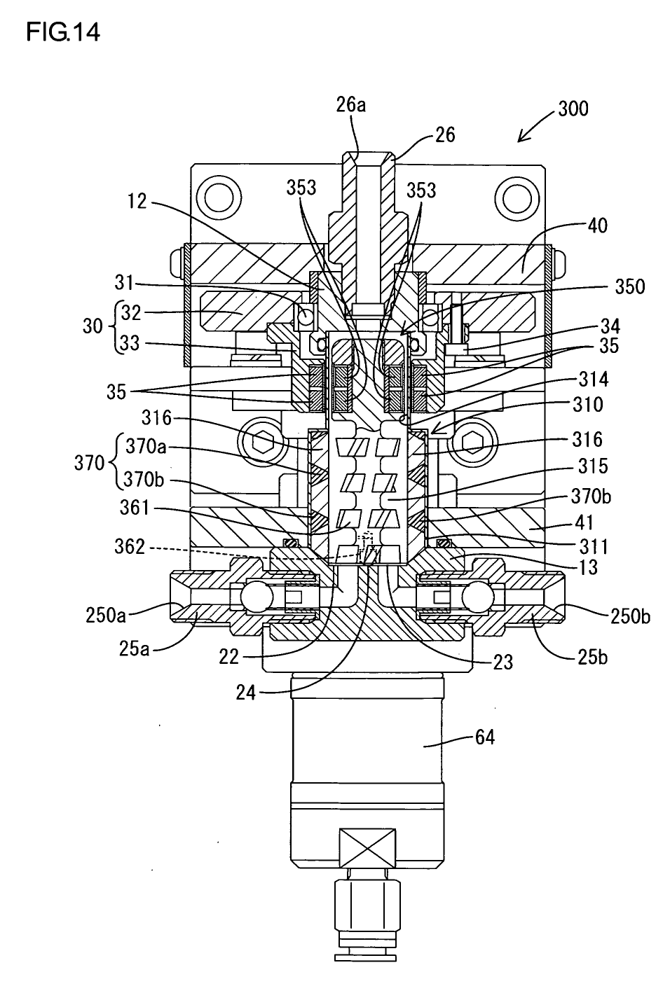

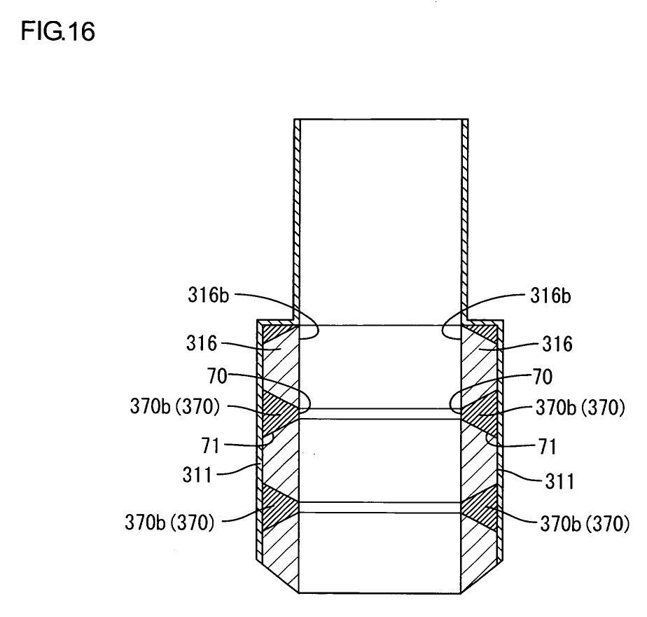

A third preferred embodiment in accordance with the present invention will be now described with reference to FIGS. 14 through 18. A multi-component mixing apparatus 300 of this embodiment is, similar to that of the first embodiment, arranged for mixing fluids each at required proportions. The fluids are, for example, a base compound such as a urethane component that is one of waterborne coating components and a cure agent such as a hydrophobic isocyanate component. The multi-component mixing apparatus 300 includes a cylindrical assembly 310 and a rotor 350 each having different configurations from those of the multi-component mixing apparatus 100 of the first embodiment. Configurations similar to the multi-component mixing apparatus 100 of the first embodiment are designated with same numerals in FIGS. 14 through 18, while the explanations are omitted.

As shown in FIG. 14, the multi-component mixing apparatus 300 includes an assembly 310 (having a cylindrical shape in this aspect), the drive gear 30, and the rotor 350. The cylindrical assembly 310 includes a cylindrical body 311 made of nonmagnetic material, the cylindrical upper support 12, and the cylindrical lower support 13. The body 311 orients the axis thereof vertical. An upper aperture of the body 311 is fitted in the upper support 12 coaxially therewith, and a lower aperture of the body 311 is fitted in the lower support 13 coaxially therewith. The cylindrical assembly 310 is vertically held between the upper base plate 40 and the lower base plate 41. The cylindrical assembly 310 is thus fixedly supported by the upper base plate 40 and the lower base plate 41. The cylindrical assembly 310 is hollow therein. A substantial portion of the upper half of the hollow defines a magnet accommodation cavity 314, and a substantial portion of the lower half of the hollow defines an agitation cavity 315.

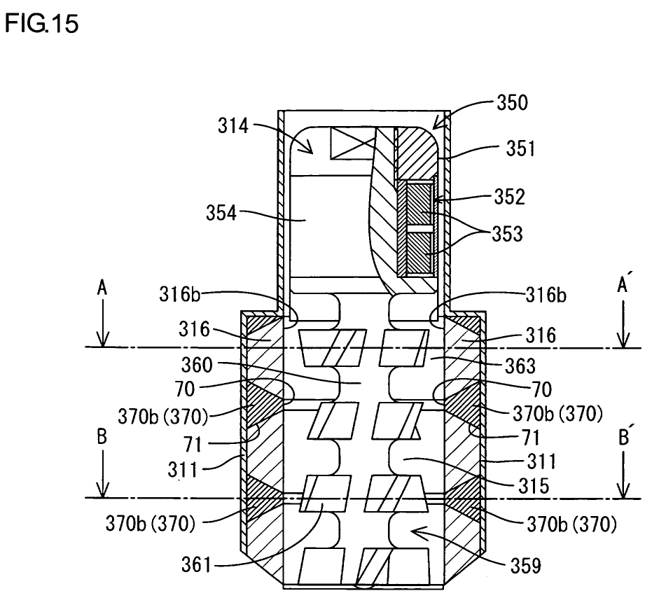

The agitation cavity 315 has first blades 316 (rotation-crossing blades) disposed therein for shearing the rotational flow of the fluids. As shown in FIGS. 15 through 17, each of the first blades 316 extends from an inner surface of the body 311. In this embodiment, two blades 316 are disposed in diametrically opposed positions in the body 311. Specifically, the first blades 316 are, for example, applied on the body 311 with the welding process. Alternatively, the first blades 316 are formed integrally with the body 311 so as to extend from the body 311 during the molding process of the body 311 (using a similar material). Each of the first blades 316 extends from the inner surface of the body 311 in the direction crossing the agitated direction of the fluids, and extends along the flow direction of the fluids (the vertical direction in the figures).

The agitation cavity 315 also has second blades 370 (flow-crossing blades) disposed therein along a circumferential direction (rotational direction) of the rotor 350. The second blades are arranged to direct the fluids flowing along an inner surface of the body 311 in the cylindrical assembly 310 from the inner surface toward an axis of the body 311 (that is, toward the agitator blades 361). In this embodiment, each of the second blades 370 extends continuously along the circumferential direction (in the rotational direction) of the rotor 350. Specifically, a plurality of (two in this embodiment) second blades 370a, 370b are disposed apart from each other in the flow direction of the fluids (the vertical direction in the figures). The second blades 370a, 370b are, for example, formed on the body 311 with the welding process. Alternatively, the second blades 370a, 370b are integrally formed with the body 311 so as to extend from the body 311 during the molding process of the body 311 (using similar material). Each of the second blades 370a, 370b extends from the inner surface of the body 311 in the direction crossing the flow direction of the fluids (the vertical direction in the figures). In other words, the second blades 370 (370a, 360b) partially narrow the inside diameter of the body 311 inwardly.

Held between a lower end surface of the body 311 and the lower support 13 is the flat bearing plate 22, as shown in FIG. 14. The bearing plate 22 is disposed perpendicular to the axis of the body 311. The bearing plate 22 has the plurality of holes 23 thicknesswisely formed therethrough. Each of the holes 23 is positioned off a center point of the bearing plate 22. The holes 23 are circumferentially spaced from each other. The bearing plate 22 has the bearing portion 24 in the center thereof.

The inlet joints 25a, 25b are secured to the lower support 13, and the cylindrical outlet joint 26 is secured to the upper support 12. The outlet joint 26 orients the axis thereof vertical. The inlet joints 25a, 25b includes the inlet ports 250a, 250b, respectively, formed therein. The inlet ports 250a, 250b are connected to the base compound supply source (not illustrated) and the cure agent supply source (not illustrated), respectively. The outlet joint 26 includes the outlet port 26a formed therein. The outlet port 26a is connected to the spray gun (not illustrated). The inlet ports 250a, 250b are in communication with the agitation cavity 315 via the lower support 13. The outlet port 26a is in communication with the agitation cavity 315 via the upper support 12. The base compound and the cure agent are supplied from the respective inlet ports 250a, 250b into the cylindrical assembly 310, flow up (generally parallel to the axis of the cylindrical assembly 310) in the cylindrical assembly 310, and flow from the outlet 26a out of the cylindrical assembly 310.

In this embodiment, the drive gear 30 is cylindrical and made of nonmagnetic material. The drive gear 30 is supported by the bearing 31 around the outer surface of the upper support 12. The drive gear 30 is coaxial with the cylindrical assembly 310. The drive gear 30 is restricted in relative movement in the vertical direction (in the axial direction of the drive gear 30). The drive gear 30 is allowed for the rotational movement about an axis coaxial with the cylindrical assembly 310. The drive gear 30 includes the cylindrical gear body 32 and the cylindrical magnet holder 33. The gear body 32 and the magnet holder 33 are assembled with the bolts 34 so as to integrally perform the rotational movement. Attached to the magnet holder 33 are even numbers of the driving magnets 35. The driving magnets 35 are circumferentially spaced from each other. The driving magnets 35 are disposed on the inner surface of the magnet holder 33, with the north poles and the south poles being alternately aligned thereon. The driving magnets 35 are closely opposed to the outer surface of the body 11 of the cylindrical assembly 10. The driving magnets 35 are thus arranged to perform the rotational movement along the outer surface of the body 11 in accordance with the rotational movement of the drive gear 30.

The motor 64 is installed on the upper base plate 40. The motor 64 has the output shaft. The output gear (not illustrated) is mounted to the output shaft. The output shaft and the output gear thus integrally perform the rotational movement. The output gear has the meshing engagement with the drive gear 30. When the motor 64 runs, rotation force from the motor 64 is transferred via the output gear to the drive gear 30. The drive gear is thus actuated to perform the rotational movement.

The rotor 350 is made of nonmagnetic material and is accommodated in the hollow of the cylindrical assembly 310. As shown also in FIG. 15, a substantial portion of the upper half of the rotor 350 is a generally column-shaped magnet holder 351, while a substantial portion of the lower half of the rotor 350 is a generally column-shaped agitator 359. The outside diameter of the magnet holder 51 is slightly smaller than the inside diameter of the body 311. The magnet holder 351 includes concavities 352 defined on an outer surface thereof. The concavities 352 are equal in number to the driving magnets 35. A plurality of driven magnets 353 are accommodated in the concavities 352. The driven magnets 353 are equal in number to the driving magnets 35. The driven magnets 353 are disposed with north poles and south poles being alternately aligned on the outside. Note that the driven magnets 353 include covers 354 attached to openings of the concavities 352, and thus the driven magnets 353 are prevented from contact with the base compound and the cure agent.

The agitator 359 includes a column-shaped support leg 360 and a plurality of agitator blades 361. The support leg 360 is coaxial with the magnet holder 351. The agitator blades 361 are disposed around an outer surface of the support leg 360. An upper end of the support leg 360 is connected to a lower end surface of the magnet holder 351 so that the agitator 359 and the magnet holder 351 integrally perform a rotational movement. A bearing ball 362 is disposed at a lower end of the support leg 360, as shown in FIG. 14. Four agitator blades 361 are disposed in a horizontal plane to define one set. Four sets of the agitator blades 361 are spaced from each other in the axial direction (the vertical direction) of the rotor 350. Consequently, sixteen agitator blades 361 in total are disposed around the support leg 360. Each of the sixteen agitator blades 361 is plate-shaped, and its flat surfaces are spirally oblique on the outer surface of the support leg 360. In other words, the flat surfaces of the agitator blades 361 are slightly inclined to the axis of the support leg 360.

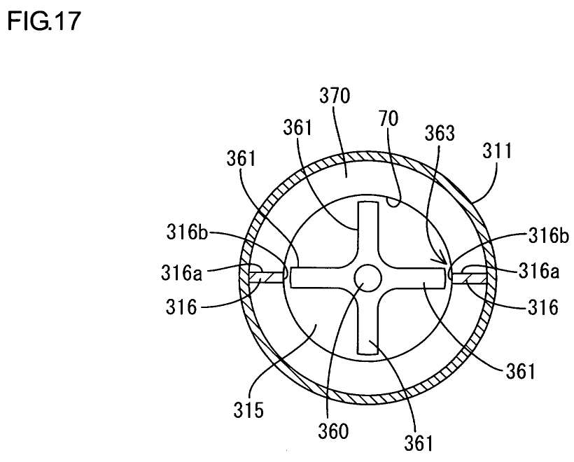

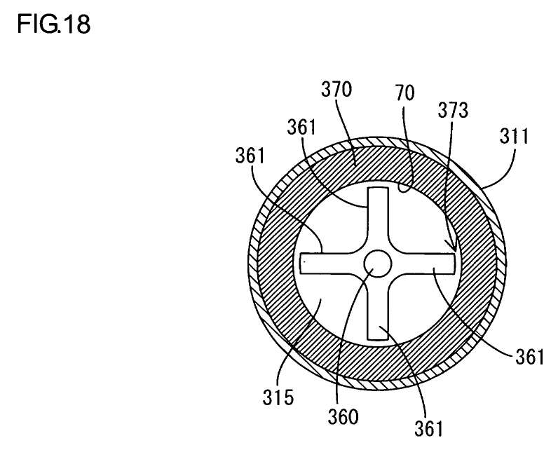

As above described, the first blades 316 and the second blades 370 are disposed on the inner surface of the body 311. On the other hand, there is a clearance 363 between each of the first blades 316 and each of the agitator blades 361, as shown in FIG. 17. Likewise, there is a clearance 373 between each of the second blades 370 and each of the agitator blades 361, as shown in FIG. 18. Each of the clearances 363, 373 is arranged to be equal to or larger than 0.1 mm (more preferably, to be equal to or larger than 0.3 mm), which is enough for allowing the agitator blades 361 to smoothly perform the rotational movement without making any contact with the first blades 316 and the second blades 370. Note that the first blades 316 are arranged for shearing the rotational flow of the fluids in the agitation cavity 15 as above described, and therefore extend in the direction crossing the rotational direction of the agitator blades 361. That is, each of the first blades 316 includes a standing wall 316a that extends in the direction crossing the rotational direction of the agitator blades 61. Also note that the second blades 370 are arranged for directing the fluids toward the agitator blades 361 in the agitation cavity 315, and therefore extend in the direction crossing the flow direction of the fluids. That is, each of the second blades 370 has a standing wall 71 (see FIG. 15) that extends in a direction crossing the flow direction of the fluids. Note that tops 70 (inner ends) of the second blades 370 extend to a height the same as tops 316b (inner ends) of the first blades 316. That is, each of the tops 70 of the second blades 370 and each of the tops 316b of the first blades 316 has an inner surface, and the inner surfaces of the tops 70 and the inner surfaces of the tops 316b are flush with each other and are continuous with each other. The standing walls 71 of the second blades 370 cross the flow direction of the fluids, however, the standing walls 71 have slightly inclined surfaces thereon. Consequently, the fluids do not easily stagnate at the basal end portions of the second blades 370, and therefore the fluids are sufficiently agitated also at the basal ends of the second blades 370.

The operation of this embodiment will be now explained.

First, when mixing the base compound with the cure agent, the drive gear 30 is actuated by the motor 64. The rotor 350 then starts the rotational movement in the cylindrical assembly 310. In this state, the base compound and the cure agent are supplied from the respective inlet ports 250a, 250b into the agitation cavity 315 of the cylindrical assembly 310. Since each of the base compound and the cure agent are lead directly into the agitation cavity 315 of the cylindrical assembly 310, the fluids are not mixed until they enter into the cylindrical assembly 310.

In the agitation cavity 315, the agitator blades 361 produce the rotational flow of the base compound and the cure agent, and the rotational flow agitates the base compound and the cure agent. The flow of the fluids produced by the rotational flow is directed outwardly (centrifugally). On the other hand, the first blades 316 radially extend from the inner surface of the body 311. The fluids are therefore sheared between the first blades 316 and the outer ends of the agitator blades 361. Since the rotary speed of the agitator blades 361 is the fastest at the outer ends thereof, agitation of the fluids is thus more effectively performed. Furthermore, the rotational movement of the agitator blades 361 produces centrifugal force, which produces the convecting flow of the fluids between the outer portions of the agitator blades 361 and inner portions of the agitator blades 361. Inner portions (the basal end side portions) of the agitator blades 361, which would less serve for agitation in nature than the outer portions, thus also provide sufficient agitation.

Also, the cylindrical assembly 310 includes the second blades 370 that are disposed along the inner surface of the body 311 and extend in the direction crossing the flow direction of the fluids. Therefore, the fluids flowing through the agitation cavity 315 in the cylindrical assembly 310 are directed inwardly by the second blades 370. The fluids are thus reliably agitated by the agitator blades 361. Though the clearances between the agitator blades 361 and the inner surface of the cylindrical assembly 310 is necessary to allow the agitator blades 361 to reliably perform the rotational movement, the fluids can flow along the wall of the clearances (along the inner wall of the cylindrical assembly 310), thereby bypassing agitation by the agitator blades 361. In this case, the fluids are not sufficiently agitated, and the agitation performance becomes lower. In view of this, the second blades 370 of this embodiment reduce or prevent such bypassing flows of the fluids along the inner surface of the body 311. That is, the second blades 370 direct the flow of the fluids from the inner surface of the body 311 toward the axis of the cylindrical assembly 310 (toward the agitator blades 361 or toward the support leg 360), thereby preventing the fluids from bypassing the agitation when flowing through the agitation cavity 315.

Specifically, in a case where the first blades 316 extend along the flow direction of the fluids as of this embodiment, the first blades 316 extend from the inner surface of the body 311 of the cylindrical assembly 310. This configuration accompanies gaps (spaces) between the inner surface of the body 311 (excepting for the portion from which the first blades are disposed) and the outer ends of the agitator blades 361. That is, this accompanies the gaps (the spaces) whereinto the agitator blades 361 are allowed to push out the fluids. Such gaps (spaces) still more easily allow the fluids to flow along the walls (the inner walls) of the gaps (the spaces) thereby bypassing agitation. Therefore, it is more preferable for the configuration having the first blades 316 to be combined with the second blades 370 as set forth in this embodiment.

The fluids are thus sufficiently agitated and mixed in the agitation cavity 15 having the first blades 316 and the second blades 370 as above described, and then flow from the outlet port 26a out of the cylindrical assembly 310 (out of the agitation cavity 315) (toward the paint gun).

With the above described multi-component mixing apparatus 300 of this embodiment, the base component and the cure agent are sufficiently agitated and mixed. Specifically, even in a case of mixing the waterborne base component and the hydrophobic component that are less miscible with each other such as in this embodiment, the shearing effect produced by the rotational movement of the agitator blades 361 and the blades 316 realizes the higher agitation and mixing performance. Furthermore, even in a case of a lower flow rate of the base component and the cure agent in the cylindrical assembly 310 (in a case of a lower flow rate per hour), the agitation performance can be further improved by increasing the rotary speed of the drive gear 30, i.e. a rotary speed of the agitator blades 361.

In this embodiment, meanwhile, another configuration could give rotation force to the rotor 350 accommodated in the cylindrical assembly 310. Namely, a transmitting member could be mounted on the rotor 350, which penetrates the cylindrical assembly 310 from the outside. With this configuration, rotation force could be applied to the transmitting member, and the rotor 50 could integrally perform a rotational movement with the transmitting member. However, with such a configuration wherein the rotated transmitting member penetrates the cylindrical assembly 310, the fluids could enter into a gap between the transmitting member and a penetration in the cylindrical assembly 310, increase the viscosity therein, and adhere thereto. The possible rotation trouble of the transmitting member and the rotor 350 is therefore a concern. In view of this, in this embodiment, magnetic force is used for giving rotation force to the rotor 350. Such a rotation trouble possibly caused by increase in viscosity of the fluids as above described is thus avoided.

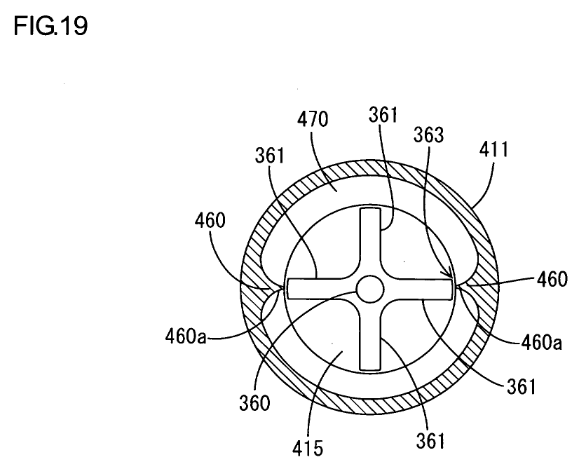

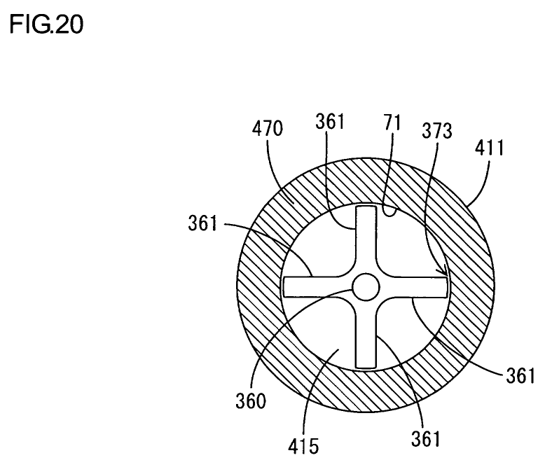

Note that the first blades 316 and the second blades 370 may be integrally formed with the body by processing the body, as illustrated in FIGS. 19 and 20. That is, a body 411 shown in FIGS. 19 and 20 has first blades 460 (the rotation-crossing blades) and second blades 470 (the flow-crossing blades) that are protrudingly formed during the processing of the body 411 using dies for molding the blades. In this case, standing walls 460a of the first blades 460 and standing walls of the second blades 470 (see FIGS. 19 and 20) have slightly inclined smooth surfaces thereon. Therefore, the fluids do not easily stagnate at the basal end portions of the first and second blades 460, 470, and therefore the fluids are sufficiently agitated also at the basal ends of the first and second blades 460, 470.

### Other Embodiments

The present invention is not limited to the embodiments described above with reference to the drawings, the following embodiments are also included within the scope of the present invention. Further various variations other than the following embodiments are also possible within the scope and spirit of the invention.

(1) In the first embodiment, the two first blades are disposed in diametrically opposed positions on the inner surface of the body. However, the number of the first blades may be one, three, or more. Furthermore, the positions of the first blades do not have to be diametrically opposed.

(2) In the second embodiment, the holes and the blocking portions are disposed circumferentially adjacent to each other in proximate to the agitator blades at the upstream side of the agitator blades, and the holes allow the flow of the fluids while the blocking portions block the flow of fluids. Thus, substantially laminar flows of the fluids flow through the holes and, right after that, the agitator blades cross the substantially laminar flows of the fluids 261. However, in accordance with the present invention, such holes and blocking portions do not necessarily have to be provided.

(3) In the second embodiment, the agitator blades are disposed at the plurality of levels, and the plurality of levels are spaced from each other in the flow direction of the fluids. However, in accordance with the present invention, the agitator blades may be disposed at a single level in the flow direction of the fluids.

(4) In the second embodiment, the plurality of agitator blades and the plurality of blocking portions (holes) are alternately disposed in the flow direction of the fluids. However, in accordance with the present invention, either or both of the agitator blades and the blocking portions (holes) may be a single in number.

(5) In the second embodiment, the agitator blades are disposed on the outer surface of the driven rotary assembly. However, in accordance with the present invention, the driven rotary assembly may be cylindrical, and the agitator blades may be disposed on an inner surface of the cylindrical driven rotary assembly.

(6) In the second embodiment, the number of the holes and the blocking portions are four each, however, in accordance with the present invention, the number may be less than three, three, five, or more than five each.

(7) In the first, second, and third embodiments, two fluids are supplied into the multi-component mixing apparatus each at respective required flow rates. However, in accordance with the present invention, the two fluids may be previously put together each at a required proportion and then supplied into the multi-component mixing apparatus.

(8) In the first, second, and third embodiments, two fluids are mixed, however, in accordance with the present invention, the number of the mixed fluids may be three or more.

(9) In the first, second, and third embodiments, a coating material is obtained as a result of mixing the fluids. However, the present invention may be used for obtaining any well-mixed liquids other than the coating material.

1. A multi-component mixing apparatus, comprising:
a cylindrical assembly having an agitation cavity defined therein, wherein a plurality of fluids flow are capable of flowing in a flow direction through the agitation cavity;
a driving rotary assembly capable of performing a rotational movement along an outer surface of the cylindrical assembly and about an axis substantially parallel to the flow direction of the fluids in the agitation cavity;
a driving magnet disposed on the driving rotary assembly;
a driven rotary assembly disposed in the cylindrical assembly, the driven rotary assembly being capable of performing a rotational movement about an axis substantially coaxial with the driving rotary assembly;
a driven magnet disposed on the driven rotary assembly;
an agitator blade disposed on the driven rotary assembly,
wherein the driven rotary assembly integrally performs a rotational movement with the rotational movement of the driving rotary assembly by magnetic force between the driving magnet and the driven magnet, and
wherein the agitator blade is arranged to perform a rotational movement in a direction crossing the flow direction of the fluids in the agitation cavity in accordance with the rotational movement of the driven rotary assembly.

2. The multi-component mixing apparatus according to claim 1, further comprising a rotation-crossing blade that is disposed on an inner surface of the cylindrical assembly, the rotation-crossing blade extending in a direction crossing a rotational direction of the agitator blade.

3. The multi-component mixing apparatus according to claim 2, wherein the rotation-crossing blade and the agitator blade define a clearance equal to or larger than 0.1 mm.

4. The multi-component mixing apparatus according to claim 1, further comprising a flow-crossing blade that is disposed on an inner surface of the cylindrical assembly along a circumferential direction of the driven rotary assembly, the flow-crossing blade extending in a direction crossing the flow direction of the fluids.

5. The multi-component mixing apparatus according to claim 2, further comprising a flow-crossing blade that is disposed on an inner surface of the cylindrical assembly along a circumferential direction of the driven rotary assembly, the flow-crossing blade extending in a direction crossing the flow direction of the fluids.

6. The multi-component mixing apparatus according to claim 3, further comprising a flow-crossing blade that is disposed on an inner surface of the cylindrical assembly along a circumferential direction of the driven rotary assembly, the flow-crossing blade extending in a direction crossing the flow direction of the fluids.

7. The multi-component mixing apparatus according to claim 4, wherein the flow-crossing blade includes at least two members disposed apart from each other in the flow direction of the fluids in the agitation cavity.

8. The multi-component mixing apparatus according to claim 5, wherein the flow-crossing blade includes at least two members disposed apart from each other in the flow direction of the fluids in the agitation cavity.

9. The multi-component mixing apparatus according to claim 6, wherein the flow-crossing blade includes at least two members disposed apart from each other in the flow direction of the fluids in the agitation cavity.

10. The multi-component mixing apparatus according to claim 5, wherein a top of the flow-crossing blade extends to a height the same as a top of the rotation-crossing blade, and wherein the top of the flow-crossing blade is continuous with the top of the rotation-crossing blade.

11. The multi-component mixing apparatus according to claim 6, wherein a top of the flow-crossing blade extends to a height the same as a top of the rotation-crossing blade, and wherein the top of the flow-crossing blade is continuous with the top of the rotation-crossing blade.

12. The multi-component mixing apparatus according to claim 8, wherein a top of the flow-crossing blade extends to a height the same as a top of the rotation-crossing blade, and wherein the top of the flow-crossing blade is continuous with the top of the rotation-crossing blade.

13. The multi-component mixing apparatus according to claim 9, wherein a top of the flow-crossing blade extends to a height the same as a top of the rotation-crossing blade, and wherein the top of the flow-crossing blade is continuous with the top of the rotation-crossing blade.

14. The multi-component mixing apparatus according to claim 4, wherein the flow-crossing blade and the agitator blade define a clearance equal to or larger than 0.1 mm.

15. The multi-component mixing apparatus according to claim 5, wherein the flow-crossing blade and the agitator blade define a clearance equal to or larger than 0.1 mm.

16. The multi-component mixing apparatus according to claim 6,wherein the flow-crossing blade and the agitator blade define a clearance equal to or larger than 0.1 mm.

17. The multi-component mixing apparatus according to claim 1, further comprising a hole and a blocking portion, the hole and the blocking portion being located circumferentially adjacent to each other proximate to the agitator blade at an upstream side of the agitator blade in the agitation cavity, wherein the hole is configured to allow the flow of the fluids therethrough, and wherein the blocking portion blocks the flow of the fluids.

18. The multi-component mixing apparatus according to claim 4, further comprising a hole and a blocking portion, the hole and the blocking portion being located circumferentially adjacent to each other proximate to the agitator blade at an upstream side of the agitator blade in the agitation cavity, wherein the hole is configured to allow the flow of the fluids therethrough, and wherein the blocking portion blocks the flow of the fluids.

19. The multi-component mixing apparatus according to claim 1, further comprising an agitation chamber that is partitioned from the outside, wherein the agitator blade perform the movement in the agitation chamber.

20. The multi-component mixing apparatus according to claim 4, further comprising an agitation chamber that is partitioned from the outside, wherein the agitator blade perform the movement in the agitation chamber.
